(19) United States
(12) Patent Application Publication
(10) Pub. No.: US 2015/0169623 A1
(43) Pub. Date: Jun. 18, 2015

(54) Distributed File System, File Access Method and Client Device

(71) Applicant: TENCENT TECHNOLOGY (SHENZHEN) COMPANY, Guangdong, Shenzhen (CN)

(72) Inventors: Haijun Wu, Shenzhen (CN); Huican Zhu, Shenzhen (CN); Dafu Deng, Shenzhen (CN); Rui Li, Shenzhen (CN); Yongqiang Zou, Shenzhen (CN); Shengyu Dong, Shenzhen (CN); Taifu Que, Shenzhen (CN); Lei Wang, Shenzhen (CN); Shaopeng Yang, Shenzhen (CN); Shuxin Zhang, Shenzhen (CN); Dayong Zhao, Shenzhen (CN); Chang Liu, Shenzhen (CN); Xiaodong Chen, Shenzhen (CN); Yinfeng Zhang, Shenzhen (CN)

(73) Assignee: TENCENT TECHNOLOGY (SHENZHEN) COMPANY LIMITED, Shenzhen (CN)

(21) Appl. No.: 14/414,501

(22) PCT Filed: Jul. 23, 2013
(86) PCT No.: PCT/CN2013/079855

§ 371 Date: Jan. 13, 2015

(30) Foreign Application Priority Data
Jul. 26, 2012 (CN) 201210261331.1

(51) Int. Cl. G06F 17/30; H04L 29/08; H04L 29/06; G06F 11/14

(52) U.S. Cl. CPC G06F 17/30203; G06F 11/1464; H04L 67/10; H04L 67/42

(57) ABSTRACT

The provided is a distributed file system, file access method and a client device. The file access method includes: accessing a file catalog stored by a master server, and obtaining routing information of a meta server associated with a to-be-accessed file from the master server; accessing the meta server according to the obtained routing information, and obtaining meta information of the to-be-accessed file from the meta server; and accessing the to-be-accessed file from multiple node servers according to the obtained meta information.

### TECHNICAL FIELD

The present disclosure relates to data storage technologies, and more particularly to a distributed file system, file access method and client device.

### BACKGROUND

At present, a typical distributed file system in industry is developed by the Google Co., which is called Global File System (GFS) for short. The GFS is composed of one master server and multiple chunk servers. The master server is configured to store a file catalog and meta information of each file in the file catalog. The meta information of each file includes the size of the file, the number of data chunks generated through dividing the file, and chunk servers where the data chunks are located. The chunk server is configured to store the data chunks generated through dividing the file. Usually, a file may be divided into multiple data chunks according to a predefined size. Each data chunk is called a chunk. These data chunks are stored in different chunk servers respectively.

Since only one master server provides the access function of the file catalog and the meta information of each file in the GSF, the concurrent access quantity of files may be restricted. Further, since the memory of the master server is finite, the number of files stored in the GFS may be restricted.

### SUMMARY

Embodiments of the present disclosure provide a distributed file system, file access method and client device, so as to increase the number of files in a single cluster and the concurrent access quantity of files.

The solution of the present disclosure is implemented as follows.

A distributed file system includes:

a master server, configured to store a file catalog and routing information of a meta server associated with each file in the file catalog; when the stored file catalog includes a file to be accessed by a client device, search for routing information of a meta server associated with the to-be-accessed file from the stored routing information and provide the found routing information to the client device, so that the client device accesses the meta server according to the routing information provided by the master server;

a meta server, configured to store meta information of a file associated with the meta server; and when receiving an access request of the client device, provide meta information of the to-be-accessed file to the client device, so that the client device accesses the to-be-accessed file from a node server according to the meta information provided by the meta server; and the number of meta servers being larger than or equal to 1; and

the node server, configured to store a data chunk generated through dividing a file and/or a backup of another data chunk of the file; and the number of node servers being larger than or equal to 1.

A file access method includes:

accessing a file catalog stored by a master server, and obtaining routing information of a meta server associated with a to-be-accessed file from the master server;

accessing the meta server according to the obtained routing information, and obtaining meta information of the to-be-accessed file from the meta server; and

accessing the to-be-accessed file from multiple node servers according to the obtained meta information.

A client device for accessing a file includes:

a first access module, configured to access a file catalog stored by a master server, and obtain routing information of a meta server associated with a file to be accessed by the client device from the master server;

a second access module, configured to access the meta server according to the routing information obtained by the first access module, and obtain the meta information of the to-be-accessed file from the meta server; and

a third access module, configured to access the to-be-accessed file from multiple node servers according to the meta information obtained by the second access module.

In the embodiments of the present disclosure, the file catalog and the meta information of files are stored separately. That is, the client device only accesses the file catalog and the routing information of the meta server associated with each file in the file catalog from the master server, but accesses the meta information of each file from the meta server. Compared with the conventional solution in which the master server provides both the access function of the file catalog and the access function of the meta information of each file, the solution of the present disclosure may provide higher Query Per Second (QPS), and may provide higher concurrent access quantity of files. Further, since the master server only store the file catalog, the distributed file system in the embodiments of the present disclosure can store more files.

### BRIEF DESCRIPTION OF THE DRAWINGS

FIG. 1 is a diagram illustrating a distributed file system according to an embodiment of the present disclosure.

FIG. 2 is a flowchart illustrating a file access method according to an embodiment of the present disclosure.

FIG. 3 is a diagram illustrating the structure of a client device according to an embodiment of the present disclosure.

FIG. 4 is a diagram illustrating the structure of a client device according to another embodiment of the present disclosure.

### DETAILED DESCRIPTION

In order to make the object, technical solution and merits of the present disclosure clearer, the present disclosure will be illustrated hereinafter with reference to the accompanying drawings and embodiments.

A distributed file system provided by an embodiment of the present disclosure is shown in FIG. 1. The distributed file system includes a master server, at least one meta server and at least one node server. The number of meta servers and the number of node servers may be set according to a cluster scale and thus is not limited in the embodiment of the present disclosure.

The distributed file system shown in FIG. 1 has a three-layer structure. The upper layer includes a master server, the middle layer includes at least one meta server, and the bottom layer includes at least one node server. Accordingly, the distributed file system provided by the embodiment of the present disclosure may be called a three-layer distributed file system.

In the distributed file system provided the embodiment of the present disclosure, the number of meta servers and the number of node servers may be set according to a cluster scale. When the cluster scale is extended according to requirements, the number of meta servers and the number of node servers also should be extended. Accordingly, the distributed file system provided by the embodiment of the present disclosure may be called extensible distributed file system, and further called eXtensible File System (XFS) for short.

Usually, the storage quantity of meta information of files is much larger than the storage quantity of the file catalog. In order to extend the distributed file system, the file catalog and the meta information of files are stored separately in the embodiment of the present disclosure. For example, the file catalog is stored in the master server, and the meta information of files is stored in the meta server. In order to associate the files in the file catalog with the meta information of files stored in the meta server respectively, the master server needs to store the routing information of a meta server associated with each file in the file catalog.

Function modules in the distributed file system shown in FIG. 1 are illustrated respectively hereinafter.

The master server may store the file catalog and the routing information of the meta server associated with each file in the file catalog.

Each meta server may store the meta information of a file associated with the meta server. The meta information of the file includes the length of the file, the number of data chunks generated through dividing the file, and node servers where each data chunk and a backup of the data chunk are located respectively. In the embodiment of the present disclosure, the meta information of the file may further include file creating time, a file creator and an abstract of each data chunk, which are not limited in the embodiment of the present disclosure.

Each node server may store at least one of a data chunk and a backup of another data chunk.

Each node server may store one or more data chunks generated through dividing a file, but is restricted to store a certain data chunk generated through dividing the file and a backup of the data chunk at the same time. That is, a data chunk and a backup of the data chunk cannot be stored in the same node server.

The distributed file system shown in FIG. 1 is taken as an example. A file (called File1) in the file catalog stored by the master server is divided into five data chunks. In order to improve the fault-tolerant ability of the distributed file system, the backups of the five data chunks need to be made. In the embodiment of the present disclosure, the five data chunks and the backups of the five data chunks may be stored in different node servers separately. A method for dividing File1 into data chunks is a conventional technology and is not illustrated herein.

In the embodiment of the present disclosure, one data chunk may have multiple backups. In order to improve the fault-tolerant ability of the distributed file system, the multiple backups of one data chunk are not stored in the same node server, but are stored in different node servers. That is, all backups of one data chunk are not stored in the same node server. Further, in order to improve the fault-tolerant ability of the distributed file system, the backups of different data chunks generated through dividing one file are not stored in the same node server.

According to the information stored by the master server, the meta server and the node server, when a client device is to access a file in the file catalog stored by the master server, the master server searches the stored routing information for the routing information of a meta server associated with the to-be-accessed file and provides the found routing information to the client device. Accordingly, the client device may initiate an access request to the meta server according to the routing information provided by the master server. When the meta server receive the access request from the client device, the meta server provides the meta information of the to-be-accessed file to the client device. Accordingly, the client device may access the to-be-accessed file according to the meta information provided by the meta server.

And thus, the client device has finished the access to the file. In the embodiment of the present disclosure, the client device only accesses the file catalog and the routing information of the meta server associated with each file in the file catalog from the master server, but accesses the meta information of each file from the meta server. Compared with the conventional solution in which the master server provides both the access function of the file catalog and the access function of the meta information of each file, the solution of the present disclosure may provide higher QPS, and may provide higher concurrent access quantity of files. Further, since the master server only store the file catalog, the file catalog stored by the master server may be extended, and the distributed file system in the embodiments of the present disclosure can store more files.

In the embodiment of the present disclosure, the master server only stores the file catalog and the routing information of the meta server associated with each file in the file catalog, but does not store the meta information of each file. Compared with the conventional solution in which the master server provides both the file catalog and the meta information of each file, the number of files in a cluster is not restricted by the finite memory of the master server in the embodiment of the present disclosure, but may be extended flexibly, and the number of meta servers and the number of node servers may also be extended flexibly.

Suppose the number of meta servers may be extended according to requirements. Each extended meta server has similar functions with an original meta server in the distributed file system. For example, the currently extended meta servers are called Server1 and Server2, Server1 is taken as an example, and Server2 has similar to with Server1.

Server1 may store the meta information of a file associated with Server1. The file associated with Server1 may be a file in the file catalog stored by the master server. Suppose the file associated with Server1 is a file (called File1) in the file catalog stored by the master server. Accordingly, Server1 stores the meta information of File1. The meta information of File1 stored by Server1 may be taken as a backup of the meta information of File1 stored by the meta server, thereby improving the fault-tolerant ability of the distributed file system.

In an extended embodiment, the file associated with Server1 may be a file that is not included in the file catalog stored by the master server, but is a file extended according to requirements. Accordingly, Server1 stores the meta information of the extended file. The master server may also add a file associated with the extended meta server such as Server1 into the file catalog, and receive and store the routing information of the extended meta server such as Server1.

Each node server extended according to requirements has similar functions with an original node server in the distributed file system. Each node server may store data chunks generated through dividing a file and/or the backups of other data chunks. The data chunks stored by each extended node server may be data chunks generated through dividing a file in the file catalog stored by the master server or the backups of other data chunks, or may be data chunks generated through dividing a newly extended file or the backups of other data chunks. The storage of data chunks may be set according to an actual situation and is not illustrated herein.

In the embodiment of the present disclosure, the master server only stores the file catalog and the routing information of the meta server associated with each file in the file catalog. Accordingly, a storage space used by the file catalog and the routing information of the meta server associated with each file in the file catalog is not large. Especially, when the files in the file catalog are named with short numerals or character codes, the storage space used by the file catalog and the routing information of the meta server associated with each file in the file catalog is smaller. Accordingly, the master server can store more file catalogs and the routing information of the meta server associated with each file in the file catalogs, thereby extending a cluster scale. In another extended embodiment of the present disclosure, the file catalog and the routing information of the meta server associated with each file in the file catalog may be stored in another distributed system that can be accessed rapidly. The storage space of the distributed system is much larger than that of the master server. Accordingly, the distributed system may store more file catalogs and the routing information of the meta server associated with each file in the file catalogs, and thus the concurrent access ability of the cluster may be improved greatly.

In the embodiment of the present disclosure, the number of meta servers may not be equal to 1. Accordingly, if one or more meta servers are failed, other normal meta servers are not influenced, and thus partial files may be read and written. In this way, the fault-tolerant ability of the distributed file system may become stronger.

And thus, the description of the distributed file system shown in FIG. 1 has been finished.

Hereinafter, a file access method provided by an embodiment of the present disclosure is illustrated.

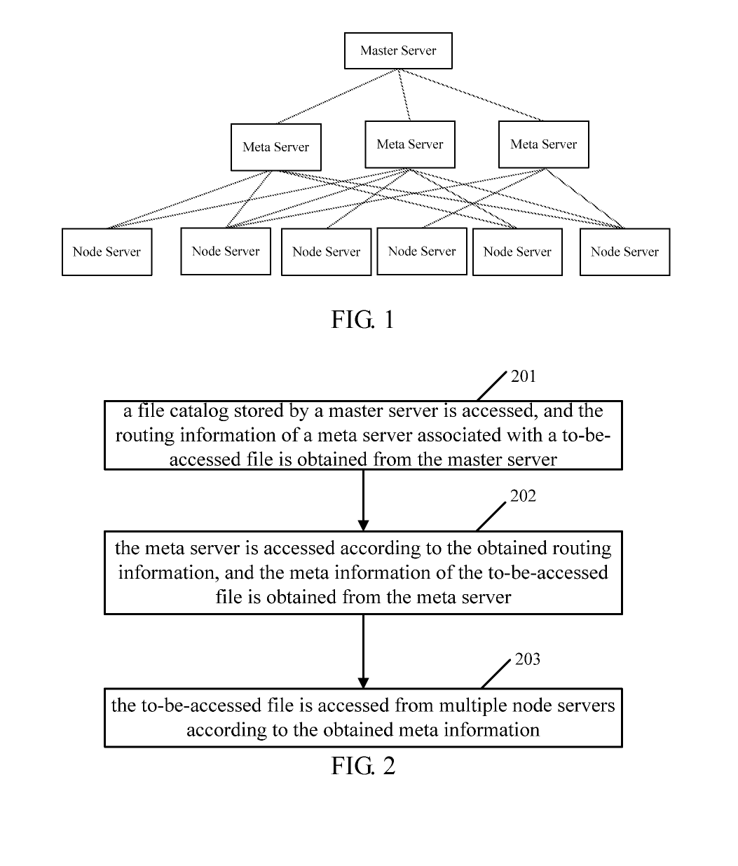

Based on the distributed file system shown in FIG. 1, an embodiment of the present disclosure provides a file access method. FIG. 2 is a flowchart illustrating a file access method according to an embodiment of the present disclosure. The file access method shown in FIG. 2 may be performed by a client device. As shown in FIG. 2, the file access method includes following blocks.

At block 201, a file catalog stored by a master server is accessed, and the routing information of a meta server associated with a to-be-accessed file is obtained from the master server.

At block 202, the meta server is accessed according to the obtained routing information, and the meta information of the to-be-accessed file is obtained from the meta server.

In the embodiment of the present disclosure, the meta information of the file includes the length of the file, the number of data chunks generated through dividing the file, and node servers where each data chunk and a backup of the data chunk are located respectively.

At block 203, the to-be-accessed file is accessed from multiple node servers according to the obtained meta information.

And thus, the description of the file access method shown in FIG. 2 has been finished. As can be seen from FIG. 2, the client device only accesses the file catalog and the routing information of the meta server associated with each file in the file catalog from the master server, but accesses the meta information of each file from the meta server. Compared with the conventional solution in which the master server provides both the access function of the file catalog and the access function of the meta information of each file, the solution of the present disclosure may provide higher QPS, and may provide higher concurrent access quantity of files.

An embodiment of the present disclosure also provides a client device for accessing a file.

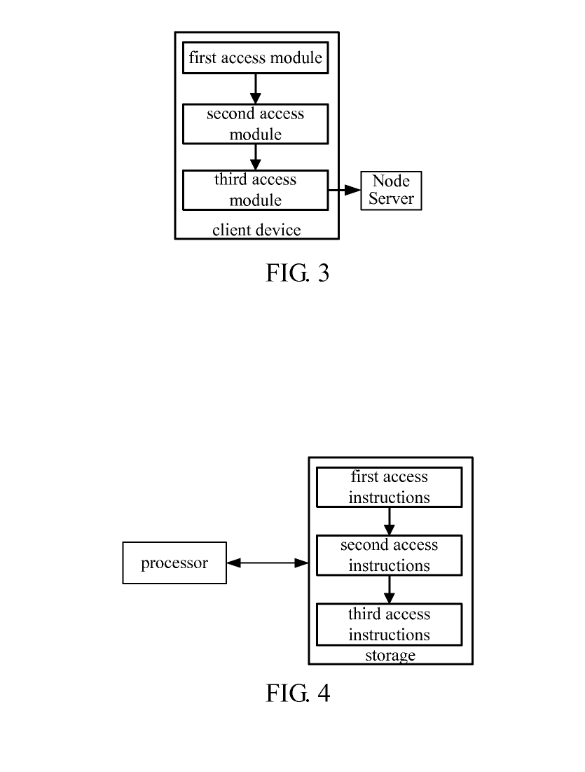

FIG. 3 is a diagram illustrating the structure of a client device according to an embodiment of the present disclosure. As shown in FIG. 3, the client device includes following modules.

A first access module may access a file catalog stored by a master server, and obtain routing information of a meta server associated with a file to be accessed by the client device from the master server.

A second access module may access the meta server according to the routing information obtained by the first access module, and obtain the meta information of the to-be-accessed file from the meta server. The meta information of the file includes the length of the file, the number of data chunks generated through dividing the file, and node servers where each data chunk and a backup of the data chunk are located respectively.

A third access module may access the to-be-accessed file from multiple node servers according to the meta information obtained by the second access module.

And thus, the description of the client device shown in FIG. 3 has been finished.

FIG. 4 is a diagram illustrating the structure of a client device according to another embodiment of the present disclosure. As shown in FIG. 4, the client device at least includes a storage and a processor communicating with the storage. The storage may include first access instructions, second access instructions and third access instructions that can be executed by the processor.

The first access instructions may access a file catalog stored by a master server, and obtain routing information of a meta server associated with a file to be accessed by the client device from the master server.

The second access instructions may access the meta server according to the routing information obtained by the first access instructions, and obtain the meta information of the to-be-accessed file from the meta server.

The third access instructions may access the to-be-accessed file from multiple node servers according to the meta information obtained by the second access instructions.

The meta information of the file includes the length of the file, the number of data chunks generated through dividing the file, and node servers where each data chunk and a backup of the data chunk are located respectively.

In the embodiments of the present disclosure, the file catalog and the meta information of each file in the file catalog are stored separately. That is, the client device only accesses the file catalog and the routing information of the meta server associated with each file in the file catalog from the master server, but accesses the meta information of each file from the meta server. Compared with the conventional solution in which the master server provides both the access function of the file catalog and the access function of the meta information of each file, the solution of the present disclosure may provide higher QPS, and may provide higher concurrent access quantity of files.

The foregoing is only preferred embodiments of the present disclosure and is not used to limit the protection scope of the present disclosure. Any modification, equivalent substitution and improvement without departing from the spirit and principle of the present disclosure are within the protection scope of the present disclosure.

1. A distributed file system, comprising:
a master server, configured to store a file catalog and routing information of a meta server associated with each file in the file catalog; when the stored file catalog includes a file to be accessed by a client device, search for routing information of a meta server associated with the to-be-accessed file from the stored routing information and provide the found routing information to the client device, so that the client device accesses the meta server according to the routing information provided by the master server;
a meta server, configured to store meta information of a file associated with the meta server; and when receiving an access request of the client device, provide meta information of the to-be-accessed file to the client device, so that the client device accesses the to-be-accessed file from a node server according to the meta information provided by the meta server; and the number of meta servers being larger than or equal to 1; and
the node server, configured to store a data chunk generated through dividing a file and/or a backup of another data chunk of the file; and the number of node servers being larger than or equal to 1.

2. The distributed file system of claim 1, wherein the meta information of the file comprises the length of the file, the number of data chunks generated through dividing the file, and node servers where each data chunk and a backup of the data chunk are located respectively.

3. The distributed file system of claim 1, wherein each node server is restricted to do at least one of following processes:
storing a data chunk and a backup of the data chunk at the same time; and
storing all backups of a data chunk.

4. The distributed file system of claim 1, further comprising at least one of an extended meta server and an extended node server;
the master server is further configured to add a file associated with the extended meta server into the file catalog, and receive and store routing information of the extended meta server;
the extended meta server is configured to store meta information of the file associated with the extended meta server; and
the extended node server is configured to store at least one of a data chunk and a backup of another data chunk.

5. A file access method, comprising:
accessing a file catalog stored by a master server, and obtaining routing information of a meta server associated with a to-be-accessed file from the master server;
accessing the meta server according to the obtained routing information, and obtaining meta information of the to-be-accessed file from the meta server; and
accessing the to-be-accessed file from multiple node servers according to the obtained meta information.

6. The method of claim 5, wherein the meta information of the file includes the length of the file, the number of data chunks generated through dividing the file, and node servers where each data chunk and a backup of the data chunk are located respectively.

7. The method of claim 5, wherein each node server is restricted to do at least one of following processes:
storing a data chunk and a backup of the data chunk at the same time; and
storing all backups of a data chunk.

8. A client device for accessing a file, comprising:
a first access module, configured to access a file catalog stored by a master server, and obtain routing information of a meta server associated with a file to be accessed by the client device from the master server;
a second access module, configured to access the meta server according to the routing information obtained by the first access module, and obtain the meta information of the to-be-accessed file from the meta server; and
a third access module, configured to access the to-be-accessed file from multiple node servers according to the meta information obtained by the second access module.

9. The client device of claim 8, wherein the meta information of the file comprises the length of the file, the number of data chunks generated through dividing the file, and node servers where each data chunk and a backup of the data chunk are located respectively.

10. The distributed file system of claim 2, further comprising at least one of an extended meta server and an extended node server;
the master server is further configured to add a file associated with the extended meta server into the file catalog, and receive and store routing information of the extended meta server;
the extended meta server is configured to store meta information of the file associated with the extended meta server; and
the extended node server is configured to store at least one of a data chunk and a backup of another data chunk.

11. The distributed file system of claim 3, further comprising at least one of an extended meta server and an extended node server;
the master server is further configured to add a file associated with the extended meta server into the file catalog, and receive and store routing information of the extended meta server;
the extended meta server is configured to store meta information of the file associated with the extended meta server; and
the extended node server is configured to store at least one of a data chunk and a backup of another data chunk.
